(19) United States
(12) Patent Application Publication
(10) Pub. No.: US 2022/0244088 A1
(43) Pub. Date: Aug. 4, 2022

(54) VEHICLE TANK LIQUID LEVEL SENSOR AND SYSTEM

(71) Applicant: James C. Gates, Madison, AL (US)

(72) Inventor: James C. Gates, Madison, AL (US)

(21) Appl. No.: 17/591,566

(22) Filed: Feb. 2, 2022

Related U.S. Application Data
(60) Provisional application No. 63/145,090, filed on Feb. 3, 2021.

(51) Int. Cl. G01F 23/296; G07C 5/00

(52) U.S. Cl. CPC G01F 23/296; G07C 5/008

(57) ABSTRACT

A vehicle tank liquid level sensor and system are provided. The vehicle tank liquid level sensor uses ultrasonic sonar sensors which are externally mounted to a tank reservoir of a vehicle to efficiently and accurately measure the level of a liquid in the tank of a vehicle. The sensor(s) are especially suitable for recreational vehicles (RVs). The sensors may be used with standard CAN BUS protocols already installed in vehicles. The present sensors and system allow for a liquid level measuring system which does not need additional holes to be drilled into the tank reservoir which might otherwise cause leakage and other problems. The system may send a wireless signal to a cell phone or computer informing the user of the tank levels.

### CROSS REFERENCE TO RELATED APPLICATIONS

The following application is a based on and claims the priority benefit of U.S. provisional application Ser. No. 63/145,090 filed Feb. 3, 2021 currently co-pending; the entire content of which is incorporated by reference.

### BACKGROUND OF THE INVENTION

A vehicle tank liquid level sensor and system are provided. The vehicle tank liquid level sensor uses ultrasonic sonar sensors which are externally mounted to a tank reservoir of a vehicle to efficiently and accurately measure the level of a liquid in the tank of a vehicle. The sensor(s) are especially suitable for recreational vehicles (RVs). The sensors may be used with standard CAN BUS protocols already installed in vehicles. The present sensors and system allow for a liquid level measuring system which does not need additional holes to be drilled into the tank reservoir which might otherwise cause leakage and other problems. The system may send a wireless signal to a cell phone or computer informing the user of the tank levels.

Liquid level sensors are common. For example, U.S. Pat. No. 9,400,204 to Schoenberg discloses an electronic fuel sensor which utilizes the characteristics of fluid (such as gasoline) to dissipate heat more readily than a gas. Specifically, the fuel sensor utilizes a linear array of sensors comprising a couple heat detector and heat source which can determine which of the sensors are in fluid and which are in air.

Further, U.S. Pat. No. 8,134,469 to Bucciero discloses a vehicle fuel tank having a housing defining an interior region, a fuel level sensor coupled to the interior region, the fuel level sensor responsive to a fuel pressure, and a radio frequency identification (RFID) device electronically coupled to the fuel level sensor configured to wirelessly transmit a signal indicative of a fuel level in the fuel tank.

Still further, U.S. Pat. No. 7,331,225 to Fukuhara et al discloses a non-contact type liquid level sensor having an electromagnetic shield plate mounted on a housing for blocking effects from an external magnetic field onto a magnetoelectric converting element.

Prior liquid sensors for vehicles typically use one or more stainless-steel rods inserted into the interior of a tank. This requires the drilling of holes into the tank to insert the rods. A low voltage electrical charge is applied to the rod(s) to measure the liquid level. The holes in the tank required to insert the rod(s) into the tank often corrode and can cause leaks. The present sensor and system avoid those problems as a result of the sensors being external to the tank and, therefore, eliminating the need for rod holes.

Wiring is generally the weakest point in any electronic Automotive/RV/Marine liquid level sensor device. The wiring adds weight to the vehicle, which therein lowers mileage efficiency of the vehicle. Further, wiring can be expensive. Even simple harnesses can be expensive because it is not uncommon for an RV to require over 40 feet of wiring for these prior art liquid level sensor systems.

The connectors used in these prior art vehicle liquid level sensor devices have to meet higher temperature and vibration requirements than normal, therein increasing the cost of the systems. Further, sensor failure problems often arise when installing wire harnesses with interconnections as a result of the wires sometimes being crossed and terminated in the wrong position. Vibrations caused when the vehicle is moving can also loosen the wires at a connection point, potentially causing failures. A connector crimped onto the wire might also have a weak crimp resulting in a poor connection between the connector pin and the wire. As a result, the wires may break or become dead over time, and rewiring a vehicle is very expensive.

Other problems with current prior art RV tank liquid level sensors which require drilling holes in the tank is that: 1) scale build-up on the sensor inside the tank can cause reduced accuracy of the level reading; 2) corrosion, even in steel tanks; 3) holes in tanks can leak; 4) holes in tanks may outgas methane and other gases which can cause further damage; 5) in servicing multiple sensors and their harnesses the chance to damage the control box and harness is increased; and 6) lime, scale and other materials can cover the sensors rendering them inaccurate or non-functional. The present sensors and system prevent these shortcomings.

The prior listed patents fail to describe a vehicle tank liquid level sensor and system which is easy to use. Further, these patents fail to provide for a vehicle tank liquid level sensor and system which uses ultrasonic sonar sensors to determine the level of a liquid within a tank.

### SUMMARY OF THE INVENTION

A vehicle tank liquid level sensor and system are provided. The vehicle tank liquid level sensor uses ultrasonic sonar sensors which are externally mounted to a tank reservoir of a vehicle to efficiently and accurately measure the level of a liquid in the tank of a vehicle. The sensor(s) are especially suitable for recreational vehicles (RVs). The sensors may be used with standard CAN BUS protocols already installed in vehicles. The present sensors and system allow for a liquid level measuring system which does not need additional holes to be drilled into the tank reservoir which might otherwise cause leakage and other problems. The system may send a wireless signal to a cell phone or computer informing the user of the tank levels.

An advantage of the present vehicle tank liquid level sensor and system is that the present sensors and system are highly accurate.

Another advantage of the present vehicle tank liquid level sensor and system is that the present sensors and system maintain the structural integrity of the tank.

Yet another advantage of the present vehicle tank liquid level sensor and system is that the present sensors and system may use current CAN BUS protocol already located in the vehicle.

And another advantage of the present vehicle tank liquid level sensor and system is that the present sensors and system are externally mounted to the tank.

Still another advantage of the present vehicle tank liquid level sensor and system is that the present sensors and system prevents corrosion of the tank.

And another advantage of the present vehicle tank liquid level sensor and system is that the present sensors and system allows for accurate reading of the liquid level within a tank even if the vehicle is parked on an incline or hill.

Another advantage of the present vehicle tank liquid level sensor and system is that in the present sensors and system there are no probes which need to be replaced (as is common on current sensors).

For a more complete understanding of the above listed features and advantages of the vehicle tank liquid level sensor and system reference should be made to the detailed description and the drawings. Further, additional features and advantages of the invention are described in, and will be apparent from, the detailed description of the preferred embodiments.

### BRIEF DESCRIPTION OF THE DRAWINGS

FIG. 1 illustrates a side view of a recreational vehicle wherein the sensor and system are illustrated.

FIG. 2 illustrates one embodiment of the sensor of the present system.

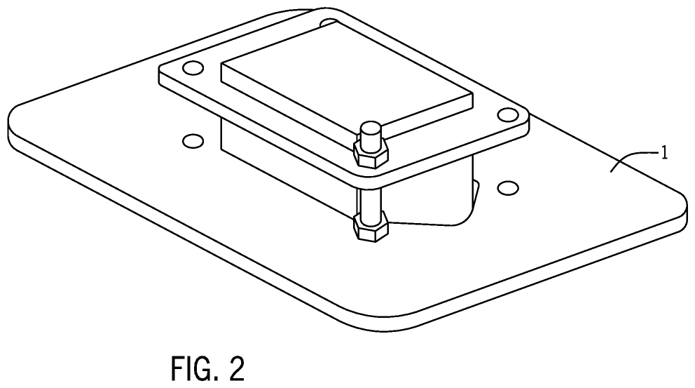

FIG. 3 illustrates an electrical schematic of the sensor in one embodiment.

FIG. 4 illustrates the potential wiring of the liquid level sensor system for a tank in one embodiment.

### DETAILED DESCRIPTION OF THE PREFERRED EMBODIMENTS

A vehicle tank liquid level sensor and system are provided. The vehicle tank liquid level sensor uses ultrasonic sonar sensors which are externally mounted to a tank reservoir of a vehicle to efficiently and accurately measure the level of a liquid in the tank of a vehicle. The sensor(s) are especially suitable for recreational vehicles (RVs). The sensors may be used with standard CAN BUS protocols already installed in vehicles. The present sensors and system allow for a liquid level measuring system which does not need additional holes to be drilled into the tank reservoir which might otherwise cause leakage and other problems. The system may send a wireless signal to a cell phone or computer informing the user of the tank levels.

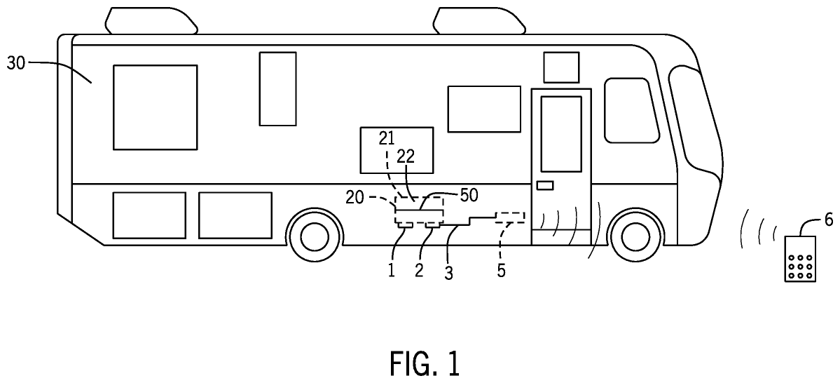

Referring now to the figures, in an embodiment a vehicle tank liquid level sensor 1 is provided. The sensors 1 may be mounted to a tank 20 reservoir of a vehicle 30. In particular, the sensor(s) 1 are generally applied to, for example, exterior of the fresh (potable) water tank 20 and the grey water tank 20 of the vehicle 30. The sensors 1 are especially suitable for recreational vehicles (RVs) which typically have multiple water tanks. FIG. 1 illustrates only one tank 20 being used for illustrative purposes; however, a greater number of tanks 20 and systems may be used on the same vehicle 30 in the present system.

The sensors 1 may be mounted to an exterior surface 21 of the tank 20 so that holes do not need to be drilled into the tank 20 for the purpose of inserting an internal level sensor (which occurs in most prior art vehicle tanks by inserting a rod). As a result of not requiring holes to be drilled into the tank 20 of the vehicle to insert internal sensors, the tanks 20 of the present device and system are substantially less likely to leak and/or need to be replaced.

The sensors 1 may use ultrasonic frequency via sonar to determine the level of a liquid 50 located within an interior 22 of the tank 20. In an embodiment, the ultrasomic frequency is, for example, preferably between 1 MHz and 2 MHz, but may be between 0.5 and 2.5 MHz. As stated above, the tanks 20 may preferably hold, for example, potable water and grey water, but may also be used to hold other liquids as well including waste water and fuel. In an embodiment, the sensors 1 may incorporate, for example, circular disks 2 which may be secured to the exterior surface 21 of the tank 20. The circular disks 2 are preferably made of ceramic and are preferable secured to the exterior bottom surface 21 of the tank 20 by a permanent adhesive. FIG. 1 illustrates the circular disk 2 and also the sensor 1 shown by itself (without the circular disk) in one embodiment. In an embodiment, the circular disk 2 may be a silicon cover for a piezo element to protect the piezo element. The piezo element may be made of a ceramic material.

The circular disks 2 housing the sensors 1 may be electrically connected to a wire 3 which may be electrically connected to a computerized device 5 (“computer” or “CPU”) located on or within the vehicle 30. In an embodiment, the computerized device 5 may further send real-time information related to the detected level of the liquid 50 within the interior 22 of the tank 20 wirelessly to a second computerized device 6 such as, for example, a cell phone or computer. The information may be sent to the second computerized device 6 by, for example, Bluetooth, Wi-Fi, through the internet or through the telephone communication network. As a result, a user may check the level of the liquid 50 within the interior 22 of the tank 20 at a remote location from the vehicle 30.

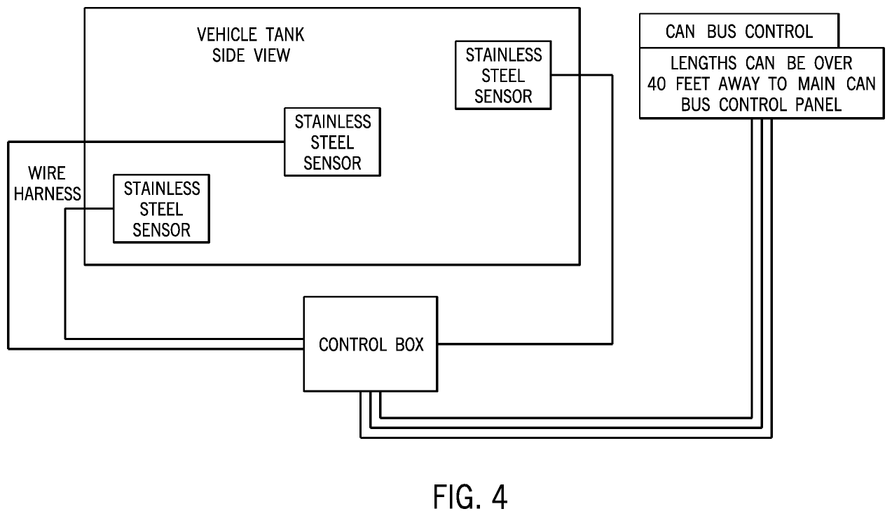

Preferably, the sensors 1 are applied to the bottom of the tank 20 for more accurate readings, but may also be applied to the side of the tank 20. In an embodiment, an adhesive is used to secure the sensor 1 to the tank 20. In the preferred embodiment, multiple sensors 1 are used on each tank 20 and an average is taken of the obtained data to increase accuracy of the liquid 50 level, especially if the vehicle 30 is parked on an incline or hill. FIG. 4 illustrates a tank with three sensors; however, a greater or fewer number of sensors may be used on a single tank to obtain an average reading.

The sensors 1 may emit an ultrahigh sound wave sonar via a transmitter that passes through the tank 20 and into the liquid 50 within the interior 22 of the tank 20 and then returns to the sensors 1 for reading. Depending on the rate at which the signal is returned to the receiver of the sensor 1, the level of the liquid 50 in the tank 20 may be precisely calculated.

In one alternative (non-wireless) embodiment, the present sensors may utilize a “daisy chain” system. More specifically, sensor 1 may be connected to sensor 2, and sensor 2 may be connected to sensor 3, and sensor 3 may therein be connected sensor 4, etc. . . . with the final sensor connected to the control box. This eliminates many feet of wiring which means saving weight and money. This daisy chain system may also reduce the number of places where long connection poor quality issues might arise. In particular, current systems often have a cable from each sensor to a hard wire into a CAN BUS or other master system. These can often be 40 feet long in an RV. The current system, however, can use, in one alternative (non-wireless) embodiment, a daisy chain to eliminate having individual sensors being needed to be wired to the master system. Instead, in this alternative embodiment wherein WI-Fi, Bluetooth or some other wireless system is not used, the present system may use short cables from sensor to sensor with just one long cable to the CAN BUS or master system in embodiments if Wi-Fi, Bluetooth or some other wireless method is not used as described above.

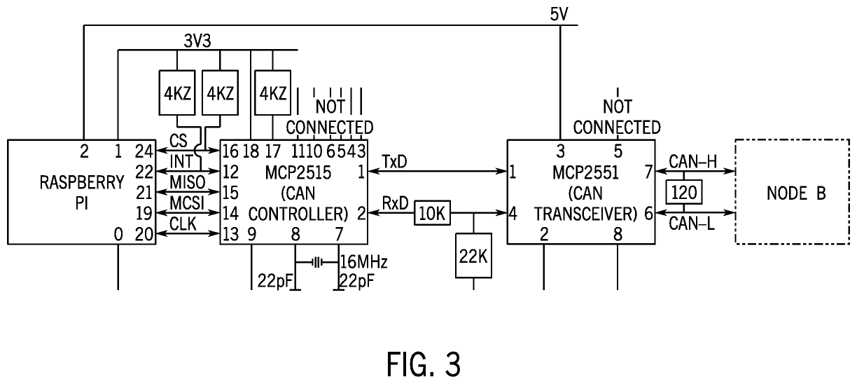

Referring now to FIG. 3, in one embodiment, an electrical schematic of the sensor system is provided. The schematic may replace the RaspberryPi (which is shown in FIG. 3) with a low-cost microcontroller like the PIC18F26K22 which would connect directly to the UM0017. In an embodiment, a PCB may be located inside the box with a connector to receive the UM0017, and 2 CAN bus connectors in parallel where CAN-H and CAN-L are shown in this schematic, and on the board, there is a microcontroller, a CAN controller, and a CAN transceiver along with a 12V to 5V regulator.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

I claim:

1) A vehicle tank liquid level sensor system comprising:
a liquid tank holder located within a vehicle;
wherein the liquid tank holder has an interior for storing a liquid and an exterior surface;
at least one sensor attached to the exterior surface of the liquid tank holder; and
wherein the sensor measures the level of liquid within the liquid tank holder.

2) The vehicle tank liquid level sensor system of claim 1 wherein the sensor uses sonar to detect the level of the liquid within the liquid tank holder.

3) The vehicle tank liquid level sensor system of claim 2 wherein the sonar is an ultrasonic frequency between 0.5 MHz and 2.5 MHz.

4) The vehicle tank liquid level sensor system of claim 1 further comprising:
a first computerized device in communication with the sensor wherein the sensor sends a liquid level reading to the computerized device and wherein the computerized device sends a signal to second computerized device related to the liquid level within the interior of the liquid tank holder.

5) The vehicle tank liquid level sensor system of claim 4 wherein the signal is sent to the second computerized device in real-time.

6) The vehicle tank liquid level sensor system of claim 1 wherein a second sensor is attached to the exterior surface of the liquid tank holder and wherein an average reading of the liquid levels detected by the sensors is taken and sent to a computerized device.

7) The vehicle tank liquid level sensor system of claim 1 wherein the sensor is at least partially ceramic.
